(19) United States
(12) Patent Application Publication
(10) Pub. No.: US 2024/0359384 A1
(43) Pub. Date: Oct. 31, 2024

(54) METHOD FOR PRODUCING A POLYMER, IN PARTICULAR A THERMOPLASTIC, WINDOW OR DOOR HOLLOW-CHAMBER PROFILE

(71) Applicant: REHAU INDUSTRIES SE & CO. KG, Rehau (DE)

(72) Inventors: Ahmad AL-SHEYYAB, Rehau (DE); Norbert FINK, Eckental (DE); Martin FROHMADER, Hof (DE); Nils GERBER, Rehau (DE); Ralf SANDER, Gesees (DE); Michael STENITSCHKA, Schortens OT Heidmühle (DE)

(21) Appl. No.: 18/686,793

(22) PCT Filed: Jun. 29, 2022
(86) PCT No.: PCT/EP2022/067831

§ 371 Date: Feb. 26, 2024

(30) Foreign Application Priority Data
Aug. 26, 2021 (DE) 10 2021 122 153.6

(51) Int. Cl. B29C 48/12; B29C 48/151; B29C 48/16; B29K 105/08; B29L 31/00

(52) U.S. Cl. CPC B29C 48/12; B29C 48/151; B29C 48/16; B29K 2105/08; B29K 2995/0097; B29L 2031/005

(57) ABSTRACT

The invention relates to a method for producing a polymer, in particular a thermoplastic, window or door hollow-chamber profile (1), wherein the hollow-chamber profile (1) which comprises at least one hollow chamber (2, 2′) is produced by means of an extrusion production process (3), wherein, during this extrusion production process (3), continuous reinforcing fibres (5) are integrated into the polymer matrix (4) of the hollow-chamber profile (1), and wherein the extrusion production process (3) is intended to produce at least one continuously fibre-reinforced core profile (10) of the hollow-chamber profile (1), which core profile has at least one hollow chamber (2), and the core profile (10) is provided with a preferably extruded outer coating (12) to improve the surface quality of the hollow-chamber profile (1). According to the invention, at least two separate core profiles (10, 10′) are produced by means of the extrusion production process (3) and are jointly covered by the outer coating (12) to produce the hollow-chamber profile (10).

The invention relates to a method for manufacturing a polymeric, in particular thermoplastic, window or door hollow-chamber profile,
wherein the hollow-chamber profile that comprises at least one hollow chamber is produced using an extrusion production process,
wherein, during this extrusion production process, continuous reinforcing fibers are integrated in the polymeric matrix of the hollow-chamber profile, and
wherein the extrusion production process is used to produce at least one continuous fiber-reinforced core profile of the hollow-chamber profile that comprises at least one hollow chamber, and the core profile is provided with a preferably extruded outer coating to improve the surface quality of the hollow-chamber profile.

Such a method is known from EP 2 528 723 B1, for example. In the case of window or door hollow-chamber profiles for framing glass panes, there is a fundamental need to achieve the best possible thermal insulation on the one hand and, on the other hand, also a requirement for sufficient mechanical stability. If a corresponding window or door hollow-chamber profile is manufactured by extrusion from non-reinforced thermoplastic material, for example polyvinyl chloride (PVC), a metal reinforcement profile must therefore generally be inserted into at least one of the hollow chambers for structural reasons. Although this considerably improves the mechanical stability, this advantage must be bought at the cost of significantly poorer thermal insulation properties due to the metal reinforcement profile also acting as a thermal bridge.

To counter this disadvantage, PVC profiles reinforced with fibers have therefore been common on the market for some time. EP 2 191 090 B1, for example, describes the incorporation of short glass fibers into the PVC matrix, which means that the use of metal reinforcement can be dispensed with in many applications.

In order to increase the length of the reinforcing fibers introduced into the profile matrix by extrusion in the end product, EP 2 953 775 A1 suggests providing the corresponding reinforcing fibers with a PVC coating before they are introduced into the extrusion process as granules, which ensures a certain degree of protection against the high mechanical stress on the fibers in the extrusion process. This ensures a greater fiber length in the end product and thus a higher mechanical stiffness.

A further improvement in mechanical properties combined with good thermal insulation is achieved by inserting non-metallic reinforcing strips, such as organic sheets, into the hollow-chamber profile. A method of this kind is described in EP 2 493 673 A1. These organic sheets usually have continuous fibers and can therefore considerably increase the mechanical load-bearing capacity of the profile.

With the measures described above, a considerable increase in rigidity can be achieved compared to a non-reinforced PVC profile. However, this is not yet sufficient for many applications. For this reason, aluminum profiles, which have very good mechanical strength, are often still used for door or window frames with very large glazing over several square meters. The disadvantage of these profiles is, of course, their poor thermal insulation properties, which is why such profiles have to be fitted with comparatively complex thermal separation constructions. Another disadvantage of aluminum profiles is that they have a comparatively high weight and are expensive.

Against this background, the generic document EP 3 529 062 suggests manufacturing the hollow-chamber profile using reactive pultrusion. In this process, continuous fiber strands, which are embedded in a polymer matrix during the process, are pulled out of a tool. Such pultrusion methods are known in the prior art for the production of thermoset profiles. The input materials for the production of thermosets are low viscosity and can therefore be easily processed using a pultrusion method. Due to their comparatively high viscosity, thermoplastic materials that are processed in a molten state are not suitable for the production of complex profiles using pultrusion. In reactive pultrusion, however, the chemical production of the thermoplastic is only carried out in the actual pultrusion process by adding corresponding monomers and/or reactive oligomers, so that continuous fiber-reinforced thermoplastic hollow-chamber profiles can also be produced in this way. A limiting factor here is that the reactive pultrusion of complex hollow-chamber profiles, such as those commonly used for windows and doors, can only be carried out at a comparatively low process speed.

Against this background, the object underlying the invention is to provide a method having the features described above, with which the production of continuous fiber-reinforced window and door hollow-chamber profiles is possible at a high process speed.

According to the invention, the object is achieved by manufacturing at least two separate core profiles by means of the extrusion production process and jointly coating them with the outer coating to produce the hollow-chamber profile. In this way, the at least two core profiles can have a significantly lower geometric complexity than is the case when manufacturing the hollow-chamber profile with only one core profile, in particular these can each have significantly fewer hollow chambers. Therefore, the production of the at least two comparatively simply designed core profiles according to the invention, and thus of the entire hollow-chamber profile, can be carried out at a significantly higher process speed. Expediently, in this case, the second core profile also comprises at least one hollow chamber. The invention is based on the knowledge that a complex hollow-chamber profile can be composed of at least two continuous fiber-reinforced core profiles, each having a comparatively simple geometry, as well as a suitable cohesive connection of these core profiles by means of, preferably non-reinforced, synthetic material. In particular, the teaching according to the invention makes it possible to manufacture window or door frames with a size of more than four square meters of glass surface, in particular more than five square meters of glass surface, preferably without steel reinforcement, at a comparatively high production speed and thus at low cost.

According to a preferred embodiment of the invention, the extrusion production process is carried out as a reactive pultrusion. The thermoplastic matrix of the core profiles is expediently produced from low-viscosity monomers and/or reactive oligomers suitable for processing in a pultrusion, which are polymerized to the thermoplastic during the reactive pultrusion. The oligomers can each be composed of 2 to 100, e.g. 5 to 50 monomers. If required, additives, e.g. initiators, for example in the form of peroxides or other radical-forming compounds, and/or catalysts and/or activators, such as stabilizers and/or impact modifiers, can be added to the reactive pultrusion. Depending on the thermoplastic to be produced, two or more different monomers and/or reactive oligomers must be added to the reactive pultrusion (e.g. polyester). However, it is also within the scope of the invention that only one monomer or oligomers differing only in chain length are used for polymerization (e.g. PMMA). Overall, reactive pultrusion allows for a very high fiber content in the core profiles, for example more than 60% by weight, in particular more than 80% by weight fiber content, so that due to this high proportion of continuous fibers a considerable increase in mechanical stability can be achieved, which is for example several times higher than with short glass fiber reinforced thermoplastic profiles. The continuous reinforcing fibers preferably consist of glass and/or carbon fibers.

The combination of the reactive pultrusion process with an outer coating of the core profiles produced in this way also ensures that the high surface requirements in window and door construction (e.g. high gloss, low soiling tendency, haptics) can be met despite the high fiber content of the core profiles. Furthermore, the weather resistance of the hollow-chamber profile required for windows and doors can be easily and efficiently ensured by selecting the appropriate material for the coating. In particular, the preferably non-reinforced coating also ensures that the profiles can be welded when they are assembled to form a frame. The coating is conveniently applied over the entire surface or only in certain areas on the surfaces of the core profiles that form the outer surface of the hollow-chamber profile. Full-surface application means that the coating ultimately forms the entire outer surface of the hollow-chamber profile. This can be expedient, if the entire outer surface of the hollow-chamber profile must have a correspondingly high surface quality. However, if individual areas of the hollow-chamber profile are concealed in later use or are not visible or accessible due to the installation of other components (e.g. glazing bead, glass pane, etc.), these surface areas can be omitted from the coating, for example. Preferably, the coating covers at least 70%, e.g. at least 80%, preferably at least 90% of the outer surface of the hollow-chamber profile.

Conveniently, the thermoplastic matrix of the core profiles is formed as a polyacrylate matrix, in particular a PMMA matrix. In this case, the corresponding monomers and/or reactive oligomers for the production of polyacrylate, e.g. polymethyl methacrylate (PMMA), are added to the reactive pultrusion. However, the production of other materials during reactive pultrusion, for example polyester, e.g. polyethylene terephthalate (PET), in particular impact-resistant polyethylene terephthalate (PET-G), or polybutylene terephthalate (PBT), or thermoplastic polyurethanes (TPU), is not excluded by this. The production of polyamide, for example PA6 or PA12, or bisphenol A (BPA), polycarbonate (PC), polyesteramides or polyimides by means of reactive pultrusion is also within the scope of the invention.

Preferably, the core profiles are first connected to one another by at least one connecting profile, preferably produced by extrusion, before the outer coating is applied. According to a preferred embodiment of the invention, the connecting profile can be produced as a connecting hollow-chamber profile having at least one closed hollow chamber. Consequently, in this case, the material of the connecting profile alone forms an additional hollow chamber, whereby the geometric complexity of the core profiles can be further reduced. Expediently, the connecting profile is produced with a wall thickness of at least 0.5 mm, e.g. at least 1 mm. After the core profiles have been joined together by the connecting profile, the resulting composite can then be covered with the outer coating.

It is also within the scope of the invention that establishing the connection of the core profiles to the hollow-chamber profile is effected by the outer coating itself. Preferably, the outer coating then forms a connecting hollow chamber together with the inner sides of the core profiles facing each other. This process variant thus results in a comparatively simple design of a hollow-chamber profile according to the invention.

According to a preferred embodiment of the invention, the application of the outer coating and, if applicable, the production of the connecting profile is takes place on-line with the extrusion production process of the core profiles. Expediently, in this case, the connecting profile and/or the outer coating is coextruded with the core profiles. In this context, the term coextrusion also means the application of the coating to the freshly produced core profiles or the production of the connecting profile by means of an extrusion immediately following the reactive pultrusion on-line, wherein in this case the intermediate cooling of the core profiles prior to the application of the coating or prior to the production of the material bond with the connecting profile is also within the scope of the invention. Alternatively, in the case of coextrusion, the core profiles and the coating and, if applicable, the connecting profile can be produced in a common tool. It is within the scope of the invention—particularly in the case of coextrusion—that at least one functional element is formed only by the coating or only by the connecting profile. Specifically, this means that only the coating material or the synthetic material for manufacturing the connecting profile is used to form the functional element and the core profiles are not involved in the geometric design of this functional element. However, the partial formation of at least one functional element using only the coating material or the material of the connecting profile is also within the scope of the invention, while in this case at least one core profile also contributes partially to the geometric design of this element. For example, the coating can be formed in some areas in the form of a receiving device, e.g. a receiving groove, for example for an elastomeric sealing element or for a latching element of another component, e.g. a glazing bead. The functional element can also be designed as a latching element for latching with a further component, e.g. a glazing bead, etc. It is also within the scope of the invention for the coating to form projections of a Eurogroove for receiving window or door locking elements. Furthermore, the coating itself can also have one or more hollow chambers and/or form one or more hollow chambers together with a core profile. advantageously, the layer thickness of the coating in a surface area of at least 50%, preferably at least 70%, of the surfaces of the core profiles covered by the coating is at most 2 mm, preferably at most 1 mm.

Preferably, the outer coating and optionally also the connecting profile are made from a polymer that adheres to the core profiles, which preferably corresponds to the material of the thermoplastic matrix of the core profiles. For example, when the thermoplastic matrix of the core profiles is formed as a polyacrylate matrix, the coating or the connecting profile is also made of polyacrylate. In principle, the same materials can be used for the coating/connecting profile as for the thermoplastic matrix of the core profiles, i.e. in addition to polyacrylate (e.g. PMMA), in particular polyester (e.g. PET, PET-G or PBT), polyurethanes (e.g. TPU), polyamides (e.g. PA6 or PA12), BPA or PC. In particular, it is also within the scope of the invention for the coating or the connecting profile to consist of polyvinyl chloride (PVC), styrene acrylonitrile (SAN) or acrylonitrile-styrene-acrylic ester (ASA), since these materials are weather-resistant. Alternatively, the coating or the connecting profile can also be made of polyester amides or polyimides.

Overall, the following combinations are particularly advantageous with regard to the material of the core profiles and the quality of the outer coating or the connecting profile:

| Core profiles | Coating/connecting profile |
|---|---|
| Acrylate, e.g. PMMA | PVC, SAN, ASA or acrylate, e.g. PMMA |
| PA, e.g. PA6 | PA, e.g. PA6 or PA6/ASA blend |
| PET-G | PVC, SAN, ASA or acrylate, e.g. PMMA |

It can also be expedient to first provide the core profiles, which have a PA matrix (in particular PA6 matrix), for example, with the outer coating of PA (in particular PA6), for example by coextrusion, and then to provide the coating on the outside with a preferably weather-resistant second coating, for example in the form of a wet or powder coating or a laminating film. This has the advantage that the surface smoothing is already ensured by the first coating and therefore the second coating, which creates the weather resistance, for example, can be very thin. For example, the formation of the second coating as a laminated aluminum foil can be advantageous, for example to allow for special color designs.

The outer coating and/or, if applicable, the connecting profile can be made of non-reinforced synthetic material. The outer coating preferably has a layer thickness of at least 0.3 mm, e.g. at least 0.5 mm. This ensures sufficient mechanical stability in the area where the two core profiles are joined. It can be particularly advantageous if the layer thickness of the coating in the connection area of the core profiles is thicker than outside this connection area, e.g. at least 50%, preferably at least 100% thicker at at least one point in the connection area than outside the connection area. The outer coating, which is expediently made of a thermoplastic, e.g. PVC, also enables direct welding of window or door profiles via the coating material if it is sufficiently thick.

It is within the scope of the invention that color pigments are added to the coating material before it is applied to the core profiles. Thus, the coating can also significantly influence the external appearance of the hollow-chamber profile. Color pigments within the meaning of the invention also include white pigments, which ensure that the hollow-chamber profile is given the “color” white that is customary for windows and doors, e.g. by using the white pigment titanium dioxide. In the manufacture of windows or doors, however, there is often a need for colored profiles, e.g. red, green or blue. Within the scope of the invention, it is now possible to carry out the coloring by means of the application of a coating, which is preferably already provided for in any case.

Another object of the invention is a hollow-chamber profile produced using the method described above. In the manufacture of a corresponding window or door frame, four miter-cut hollow-chamber profiles can then be joined together in a known manner, for example by welding, gluing or by means of separate connecting elements inserted at the ends. The hollow-chamber profile can be designed as a blind frame profile or sash frame profile. The cumulative cross-sectional area of all core profiles including the cross-sectional area of any hollow chambers can be more than 50%, preferably more than 70% of the cross-sectional area of the hollow-chamber profile including the hollow chamber(s).

In the following, the invention is explained in detail using a drawing showing only one exemplary embodiment. The Figures schematically show in:

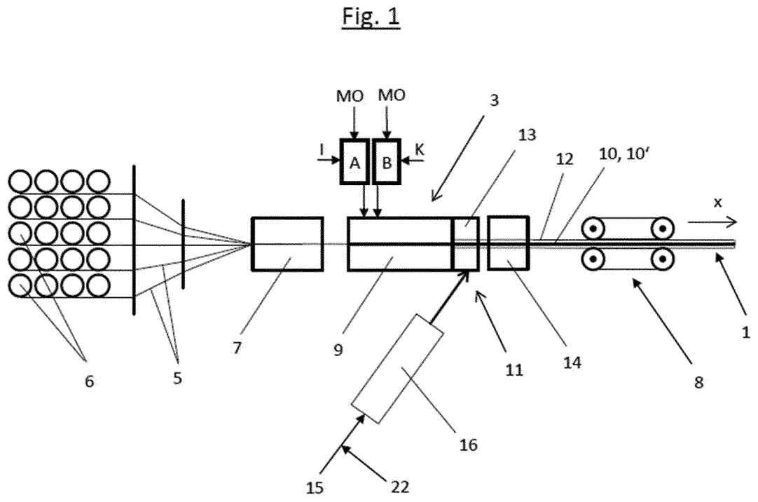

FIG. 1a a method according to the invention for manufacturing a window hollow-chamber profile;

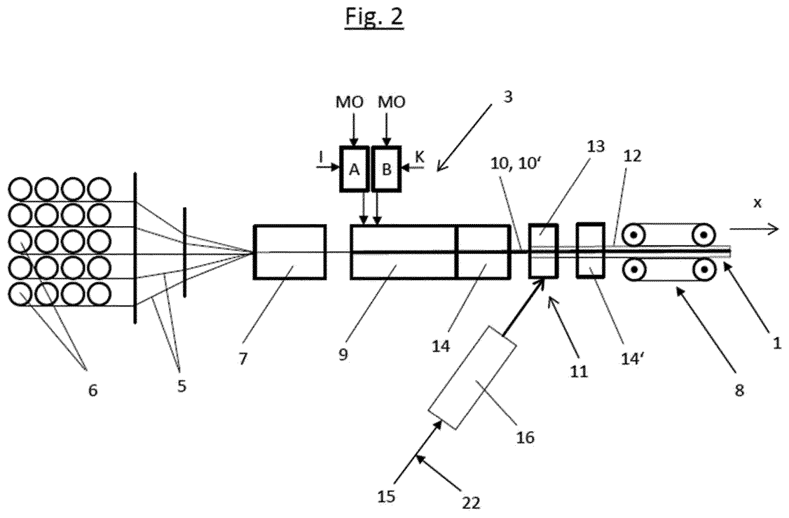

FIG. 2 an alternative manufacturing method according to the invention;

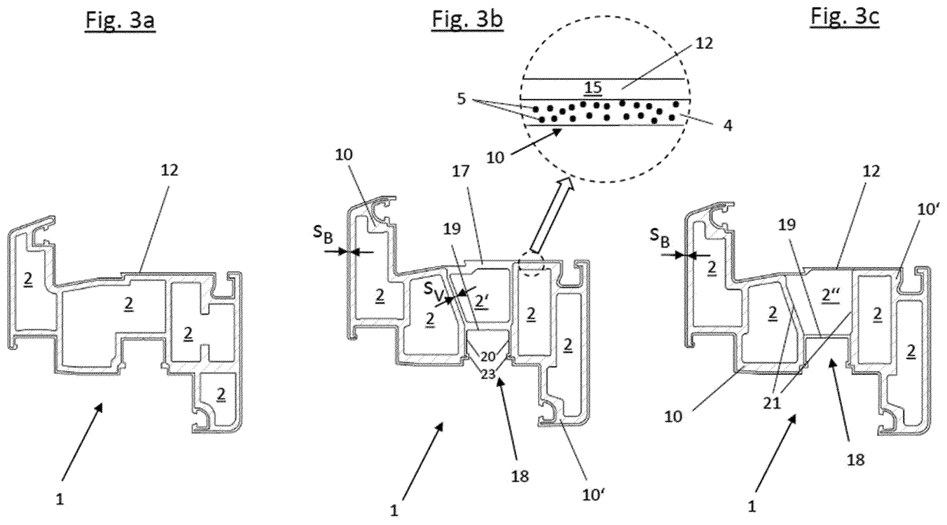

FIG. 3a a cross-sectional view of a hollow-chamber profile manufactured according to the prior art;

FIG. 3b, c hollow-chamber profiles manufactured according to invention, for example with a method according to FIG. 1 or 2 in a cross-sectional view and

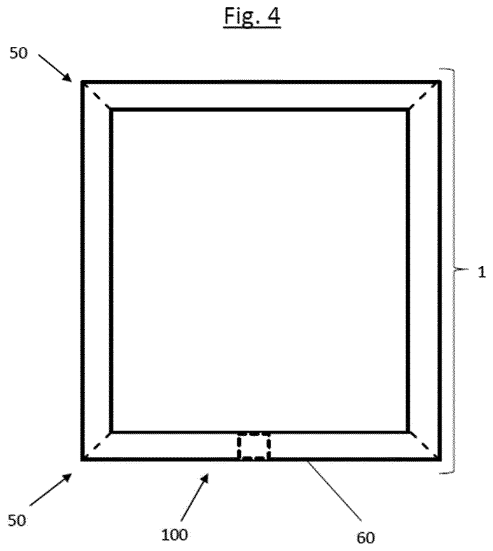

FIG. 4 a top view of a window frame made from hollow-chamber profiles according to the invention.

FIG. 1 shows a method according to the invention for manufacturing a thermoplastic window hollow-chamber profile 1. In this method, the hollow-chamber profile 1 having several hollow chambers 2 (cf. FIG. 3b, c) is produced using a extrusion production process 3. During this extrusion production process 3, continuous reinforcing glass fibers 5 are integrated into the thermoplastic matrix 4 of the hollow-chamber profile 1, which are first drawn from rolls 6 and preheated in a preheating station 7. In the exemplary embodiment, the extrusion production process 3 is designed as reactive pultrusion. Here, the freshly produced hollow-chamber profile 1 is pulled out of the heated pultrusion die 9 over the continuous reinforcing fibers 5 in production direction x by means of a drawing die 8. The reactive pultrusion 3 is used to produce two separate continuous fiber-reinforced thermoplastic core profiles 10, 10′ (see also FIG. 3b, c) of the hollow-chamber profile 1, each having several hollow chambers 2. Here, the thermoplastic matrix 4 of these two core profiles 10, 10′ produced in parallel is produced from low-viscosity monomers and/or reactive oligomers—both designated MO—which are polymerized to the thermoplastic during the reactive pultrusion 3. In addition to the monomers and/or reactive oligomers MO, initiators I and catalysts K are added to the reactive pultrusion 3 to guide the chemical reaction taking place therein. In the exemplary embodiment, the monomers or oligomers designated MO are added to the reactive pultrusion in two components A and B to polymerize the thermoplastic. Component A contains monomers/oligomers MO and initiators 1, while component B contains catalysts K in addition to the monomers/oligomers MO. This ensures that a reaction mixture containing mono-/oligomers MO as well as initiators I and catalysts K is only present in the pultrusion die 9 and that polymerization is therefore only started in the pultrusion die 9. The polymerization speed can also be controlled via the heating of the pultrusion die 9. In the exemplary embodiment, the thermoplastic matrix 4 can be formed as a polyacrylate matrix, in particular a PMMA matrix. The two core profiles 10, 10′ produced simultaneously in parallel by means of reactive pultrusion 3 are provided with an outer coating 12 of non-reinforced synthetic material 15, e.g. PVC, by means of coextrusion 11 in order to improve the surface quality of the hollow-chamber profile 1. In the exemplary embodiment shown in FIG. 1, coextrusion 11 takes place immediately after reactive pultrusion 3 without intermediate cooling. Here, the coextrusion tool 13 is arranged directly behind the outlet of the tool 9 for reactive pultrusion 3 and coats the core profiles 10, 10′ on-line. Only then is the coextruded hollow-chamber profile 1 cooled in a cooling device 14, e.g. a water bath. Alternatively, the reactive pultrusion 3 and the coextrusion 11 can also be carried out in a common die.

In the exemplary embodiment according to FIG. 2, however, intermediate cooling of the two core profiles 10, 10′, takes place first in a cooling device 14 prior to coextrusion of the coating 12, which also takes place on-line. This is particularly advantageous when coextruding a comparatively thick coating 12 due to the high heat input in order to stabilize the core profiles 10, 10′ before coextrusion 11. The thermoplastic matrix 4 of the core profiles 10, 10′ is in turn formed as a polyacrylate matrix. The coextruded coating 12 consists of non-reinforced PVC material 15, which is fed to an extruder 16 provided for coextrusion 11, and thus consists of a polymer 15 that adheres very well to the core profiles 10, 10′. After coextrusion 11 of the coating 12, the hollow-chamber profile 1 is finally cooled and calibrated in a further cooling device 14′ (e.g. a water bath). Furthermore, another drawing die is optionally provided between the first cooling device 14 and the coextrusion 11 (not shown).

FIGS. 3b, c show window hollow-chamber profiles 1 produced according to the invention, which can be produced using the methods described in FIG. 1 or 2, for example. The enlarged detail of FIG. 3b shows the reinforcing fibers 5 embedded in the thermoplastic matrix 4 of the core profiles 10, 10′ as well as the coating 12 made of the coating material 15, which is shown here in an exaggerated thickness. It can be seen in FIGS. 3b and 3c that the two separately produced core profiles 10, 10′ are jointly covered by the extruded outer coating 12. In the exemplary embodiment according to FIG. 3b, the core profiles 10, 10′ were first connected to one another other by a connecting profile 17 made of non-reinforced synthetic material, e.g. PVC, produced by extrusion before the outer coating 12 was applied, and the resulting composite was then covered with the coating 12. The connecting profile 17 is designed as a connecting hollow-chamber profile with a closed hollow chamber 2′ and a wall thickness sv of at least 0.5 mm. The material of the connecting profile 17 thus forms the additional hollow chamber 2″ alone. The connecting profile 17 is produced on-line using reactive pultrusion of the core profiles 10, 10′. In the exemplary embodiment according to FIG. 3b, the connecting profile 17 and the outer coating 12 are coextruded with the core profiles 10, 10′ (for simplification, the production of the connecting profile 17 is not shown in the process diagrams according to FIGS. 1, 2). In the exemplary embodiment according to FIG. 3c, the connection of the core profiles 10, 10′ to the hollow-chamber profile 1 is established by the outer coating 12 itself. In this case, the outer coating 12 made of non-reinforced synthetic material 15 forms a connecting hollow chamber 2″ together with the inner sides 21 of the core profiles 10, 10′ facing one another. In both exemplary embodiments according to FIG. 3b, c, the outer coating 12 has a layer thickness SB of at least 0.3 mm. The proportion by weight of the reinforcing fibers 5 in the core profiles 10, 10′ is more than 80% in the exemplary embodiment. In FIGS. 3b, c, the window hollow-chamber profile 1 is designed as a sash frame profile. It can be seen that the hollow-chamber profile 1 has a respective euronut 18 with a groove base 19 and two groove side surfaces 20 with projections 23 for receiving locking elements (not shown). The groove base 19 of this euronut 18 is formed by the connecting profile 17 together with the coating 12 in the exemplary embodiment shown in FIG. 3b and by the coating 12 alone in the example shown in FIG. 3c. The hollow-chamber profiles 1 shown in FIG. 3b, c can be colored accordingly by adding color pigments 22 to the material 15 of the coating 12 before application to the core profiles 10, 10′ (see FIGS. 1, 2). In addition to the use of classic white pigments 22, e.g. titanium dioxide, color pigments 22 can also be used in particular, which give the coating 12 a “real” color and lead, for example, to a red, green, blue, gray, yellow or even black coloring of the hollow-chamber profile 1. In comparison to the hollow-chamber profiles according to the invention in FIGS. 3b, c, FIG. 3a shows a hollow-chamber profile 1 according to the prior art, which only has a single core profile 10 covered by a coating 12.

In the exemplary embodiment according to FIG. 4, a rectangular hollow chamber frame 100 of a window or door profile is formed by first cutting a hollow-chamber profile 1 according to the invention to a corresponding miter in each of the corners 50, so that only the outer wall 60 remains there. The hollow chamber frame 100 is then formed by bending the remaining outer wall 60 in each of the corners 50. Thus, the entire hollow chamber frame 100 (usually composed of four profiles) consists of a single hollow-chamber profile 1, which is connected to itself, preferably welded, in one of the corners to form the closed frame 100. The advantage here is that the reinforcing fibers 5 run completely around the outer wall 60 and thus contribute to very high stability.

1. A method for manufacturing a polymeric, in particular thermoplastic window or door hollow-chamber profile,
wherein the hollow-chamber profile that comprises at least one hollow chamber is produced using a extrusion production process,
wherein, during this extrusion production process, continuous reinforcing fibers are integrated in the polymeric matrix of the hollow-chamber profile, and
wherein the extrusion production process is used to produce at least one continuous fiber-reinforced core profile of the hollow-chamber profile comprising at least one hollow chamber, and the core profile is provided with a preferably extruded outer coating to improve the surface quality of the hollow-chamber profile,
wherein at least two separate core profiles are produced by means of the extrusion production process and are jointly covered by the outer coating in order to produce the hollow-chamber profile.

2. The method according to claim 1, wherein the extrusion production process is carried out as a reactive pultrusion.

3. The method according to claim 1, wherein the core profiles are first connected to one another by at least one connecting profile, preferably produced by way of extrusion, prior to the application of the outer coating.

4. The method according to claim 3, wherein the connecting profile is manufactured as a connecting hollow-chamber profile that comprises at least one closed hollow chamber.

5. The method according to claim 3, wherein the connecting profile is produced with a wall thickness of at least 0.5 mm.

6. The method according to claim 1, wherein the connection of the core profiles to the hollow-chamber profile is established by the outer coating.

7. The method according to claim 6, wherein the outer coating forms a connecting hollow chamber together with the inner sides of the core profiles facing one another.

8. The method according to claim 1, wherein the application of the outer coating and, if applicable, the production of the connecting profile takes place on-line with the extrusion production process of the core profiles.

9. The method according to claim 8, wherein, if applicable, the connecting profile and/or the outer coating are coextruded with the core profiles.

10. The method according to claim 1, wherein the outer coating and/or, if applicable, the connecting profile are produced from non-reinforced synthetic material.

11. The method according to claim 1, wherein the outer coating is produced with a layer thickness (s_{B}) of at least 0.3 mm.

12. A hollow-chamber profile, manufactured according to a method in accordance with claim 1.
